(19) United States
(12) Patent Application Publication
(10) Pub. No.: US 2025/0379504 A1
(43) Pub. Date: Dec. 11, 2025

(54) SWITCHING CONTROL CIRCUIT, INTEGRATED CIRCUIT, AND POWER SUPPLY CIRCUIT

(71) Applicant: FUJI ELECTRIC CO., LTD., Kawasaki-shi (JP)

(72) Inventor: Yukihiro YAGUCHI, Matsumoto-city (JP)

(73) Assignee: FUJI ELECTRIC CO., LTD., Kawasaki-shi (JP)

(21) Appl. No.: 19/188,853

(22) Filed: Apr. 24, 2025

(30) Foreign Application Priority Data
Jun. 5, 2024 (JP) 2024-091475

(51) Int. Cl. H02M 1/08; H02M 1/42; H02M 3/155

(52) U.S. Cl. CPC H02M 1/08; H02M 1/4208; H02M 3/155

(57) ABSTRACT

A switching control circuit for a power supply circuit, including: a driver circuit that turns on the transistor after an inductor current reaches a first value, and turns off the transistor in response to a first time period having elapsed; an estimation circuit that estimates whether an effective value of the AC voltage is a first level or a second level, based on a second time period, the first time period, and an output voltage; a first output circuit that, in response to an inductor current reaching the first value, sets a slope of an output thereof to first and second slopes, respectively when the effective value is the first and second levels; and a second output circuit that outputs, as the first time period, a period from when the inductor current reaches the first value to when the output of the first output circuit reaches a predetermined level.

### CROSS-REFERENCE TO RELATED APPLICATIONS

The present application claims priority pursuant to 35 U.S.C. § 119 from Japanese patent application number 2024-091475 filed on Jun. 5, 2024, the entire disclosure of which is hereby incorporated by reference herein.

### BACKGROUND

### Technical Field

The present disclosure relates to a switching control circuit, an integrated circuit, and a power supply circuit.

### Description of the Related Art

A typical power factor correction circuit (hereinafter, referred to as PFC circuit) that operates in a critical mode shapes the waveform of the peak values of an inductor current flowing through an inductor into a waveform similar to that of a rectified voltage obtained by rectifying an alternating current (AC) voltage, to thereby improve power factor (for example, Japanese Patent Application Publication No. 2023-044599, U.S. Pat. No. 7,538,525).

Incidentally, a switching control circuit that switches a transistor to control the PFC circuit determines on-width of a transistor according to an output voltage. In this event, the switching control circuit may compare a voltage corresponding to the output voltage and, for example, a ramp wave, to determine the on-width, using a comparator. Then, when the voltage corresponding to the output voltage is low, the switching control circuit may not be able to correctly determine the on-width due to the limit of the control range of the comparator.

### SUMMARY

A first aspect of the present disclosure is a switching control circuit for a power supply circuit that generates an output voltage at a target level from an alternating current (AC) voltage inputted thereto, the power supply circuit including an inductor configured to receive a voltage corresponding to the AC voltage, and a transistor configured to control an inductor current flowing through the inductor, the switching control circuit being configured to control switching of the transistor, the switching control circuit comprising: a driver circuit configured to turn on the transistor, after the inductor current reaches a first value, and turn off the transistor, in response to a first time period corresponding to the output voltage having elapsed; an estimation circuit configured to estimate whether an effective value of the AC voltage is a first level or a second level higher than the first level, based on a second time period during which the transistor is off, the first time period, and the output voltage; a first output circuit configured to, in response to the inductor current reaching the first value, change a slope of an output, with a first slope, when the effective value is the first level, and change the slope of the output, with a second slope greater than the first slope, when the effective value is the second level; and a second output circuit configured to output, as the first time period, a time period after the inductor current reaches the first value until the output reaches a level corresponding to the output voltage.

A second aspect of the present disclosure is a power supply circuit configured to generate an output voltage at a target level from an alternating current (AC) voltage inputted thereto, the power supply circuit comprising: an inductor configured to receive a voltage corresponding to the AC voltage; a transistor configured to control an inductor current flowing through the inductor; a switching control circuit configured to control switching of the transistor, the switching control including a circuit driver circuit configured to turn on the transistor, after the inductor current reaches a first value, and turn off the transistor, in response to a first time period corresponding to the output voltage having elapsed, an estimation circuit configured to estimate whether an effective value of the AC voltage is a first level or a second level higher than the first level, based on a second time period during which the transistor is off, the first time period, and the output voltage, a first output circuit configured to, in response to the inductor current reaching the first value, change a slope of an output, with a first slope, when the effective value is the first level, and change the slope of the output, with a second slope greater than the first slope, when the effective value is the second level, and a second output circuit configured to output, as the first time period, a time period after the inductor current reaches the first value until the output reaches a level corresponding to the output voltage.

### BRIEF DESCRIPTION OF THE DRAWINGS

FIG. 1 is a diagram illustrating an example of an AC-DC converter 10.

FIG. 2 is a diagram illustrating an example of a power factor correction IC 26a.

FIG. 3 is a diagram illustrating an example of a switching control circuit 204a.

FIG. 4 is a diagram illustrating an example of an operation of an estimation circuit 301.

FIG. 5A is a diagram illustrating an example of changing the slope of an output Vr with a slope S1.

FIG. 5B is a diagram illustrating an example of changing the slope of an output Vr with a slope S2.

FIG. 6 is a diagram illustrating an example of an operation of a switching control circuit 204a.

FIG. 7 is a diagram illustrating an example of an operation of a switching control circuit 204a.

FIG. 8 is a diagram illustrating an example of an operation of a switching control circuit 204a.

FIG. 9 is a diagram illustrating an example of an operation of a switching control circuit 204a.

FIG. 10 is a diagram illustrating an example of a switching control circuit 204b.

FIG. 11 is a diagram illustrating an example of an operation of a switching control circuit 204b.

FIG. 12 is a diagram illustrating an example of an operation of a switching control circuit 204b.

FIG. 13 is a diagram illustrating an example of an AC-DC converter 12.

FIG. 14 is a diagram illustrating an example of a power factor correction IC 26b.

FIG. 15 is a diagram illustrating an example of an oscillator circuit 502.

FIG. 16 is a diagram illustrating an example of a power factor correction IC 26c.

FIG. 17 is a diagram illustrating an example of an oscillator circuit 506.

### DETAILED DESCRIPTION

At least following matters will become apparent from the descriptions of the present description and the accompanying drawings. It is assumed, hereinafter, that a “circuit” according to an embodiment of the present disclosure includes not only an analog circuit and a logic circuit of a wired logic type, but also a functional block (or means) that is included in a digital signal processor (DSP), a microcomputer, or the like, and that is capable of executing digital arithmetic processing.

Hereinafter, embodiments of the present disclosure will be described with reference to the drawings. The same or equivalent constituent elements, members, and the like illustrated in the drawings are given the same reference numerals, and repetitive description is omitted as appropriate.

### Embodiments

### Overview of AC-DC Converter 10

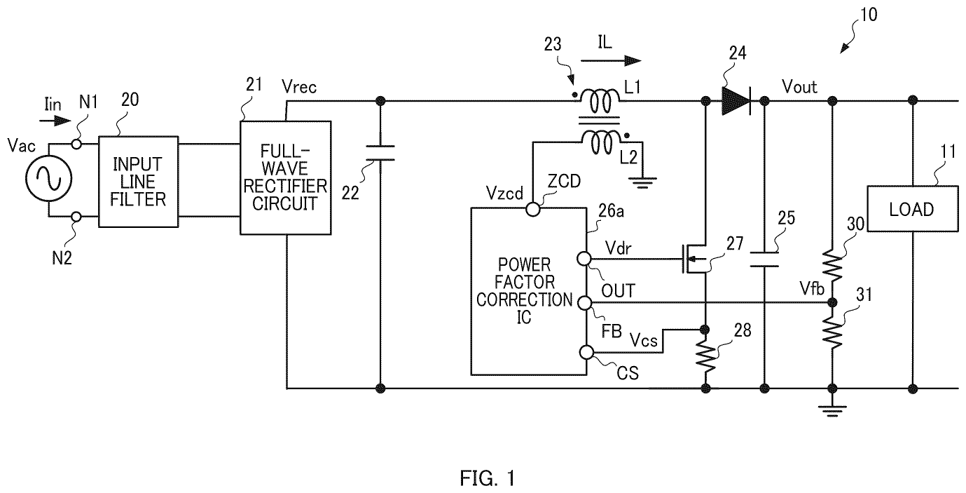

FIG. 1 is a diagram illustrating a configuration of an AC-DC converter 10 which is an embodiment of the present disclosure. The AC-DC converter 10 is a boost power factor correction (PFC) circuit to generate an output voltage Vout at a target level from an alternating-current (AC) voltage Vac of a commercial power supply.

The AC-DC converter 10 includes an input line filter 20, a full-wave rectifier circuit 21, capacitors 22, 25, a transformer 23, a diode 24, a power factor correction IC 26a, an n-type metal-oxide-semiconductor (NMOS) transistor 27, and resistors 28, 30, 31. Note that the AC-DC converter 10 corresponds to a “power supply circuit” and the current flowing from the commercial power supply to the AC-DC converter 10 is referred to as input current Iin.

The input line filter 20 attenuates both the noise from the AC power supply (e.g., nodes N1, N2) side and the noise from the AC-DC converter 10 side. The AC voltage Vac is applied to the nodes N1, N2 of the input line filter 20. The input line filter 20 then applies, to the full-wave rectifier circuit 21, the AC voltage Vac with noise attenuated.

The full-wave rectifier circuit 21 in FIG. 1 full-wave rectifies the predetermined AC voltage Vac inputted thereto, and outputs a resultant voltage, as an input voltage Vrec, to the capacitor 22 and the transformer 23. Note that the AC voltage Vac is a voltage, for example, with an effective value of 100 V or 240 V and a frequency in a range of from 50 to 60Hz. Hereinafter, in an embodiment of the present disclosure, a voltage basically refers to a difference in potential relative to a reference point (GND in a figure), however, the AC voltage Vac refers to a voltage across terminals. Note that 100 V corresponds to a “first level”, and 240 V corresponds to a “second level”. However, they are not limited to 100 V or 240 V as long as they are two different effective values.

The capacitor 22 smooths the input voltage Vrec, the capacitor 25 is charged with the output voltage of a boost chopper circuit, and the transformer 23 has a main coil L1 and an auxiliary coil L2 magnetically connected to the main coil L1. Here, in an embodiment of the present disclosure, the auxiliary coil L2 is formed by winding such that the polarity of the voltage generated at the auxiliary coil L2 is opposite to that of the voltage generated at the main coil L1. Then, a voltage Vzcd generated at the auxiliary coil L2 is applied to a terminal ZCD of the power factor correction IC 26a (described later). Note that the main coil L1 corresponds to an “inductor”.

The main coil L1 and the NMOS transistor 27 configure a boost chopper circuit, together with the capacitor 25. Thus, a charge voltage of the capacitor 25 results in the direct-current (DC) output voltage Vout.

Further, it is assumed that when an inductor current IL flows through the main coil L1 in the direction of an arrow, the direction in which the inductor current IL flows is a positive direction, and when the inductor current IL flows in the direction opposite to the direction of the arrow, the direction in which the inductor current IL flows is a negative direction.

The power factor correction IC 26a is an integrated circuit to control switching of the NMOS transistors 27 such that the level of the output voltage Vout reaches a target level (e.g., 400 V) while the input power factor of the AC-DC converter 10 is improved. Specifically, the power factor correction IC 26a drives the NMOS transistor 27, based on the inductor current IL flowing through the main coil L1 and the output voltage Vout. Although details of the power factor correction IC 26a will be described later, the power factor correction IC 26a has terminals ZCD, FB, OUT, and CS. Note that in an embodiment of the present disclosure, other terminals (e.g., a ground terminal) other than the terminal ZCD and the like of the power factor correction IC 26a are omitted for convenience.

The NMOS transistor 27 is a power transistor to control power to a load 11 of the AC-DC converter 10a. Note that in an embodiment of the present disclosure, the NMOS transistor 27 is an n-type metal oxide semiconductor (NMOS) transistor, but it is not limited thereto, and may be a switching element, such as a bipolar transistor or the like, other than the above. Further, the gate electrode of the NMOS transistor 27 is connected to the terminal OUT.

The resistor 28 is an element to detect the inductor current IL flowing through the NMOS transistor 27. In response to the NMOS transistor 27 being turned on, the inductor current IL flows through the resistor 28, and the resistor 28 generates a voltage Vcs corresponding to the inductor current IL. The voltage Vcs is applied to the terminal CS of the power factor correction IC 26a.

The resistors 30, 31 configure a voltage divider circuit to divide the output voltage Vout, to thereby generate a feedback voltage Vfb to be used in switching the NMOS transistor 27. Note that the feedback voltage Vfb generated at the node at which the resistors 30, 31 are connected is applied to the terminal FB.

### Power Factor Correction IC 26a

### Configuration of Power Factor Correction IC 26a

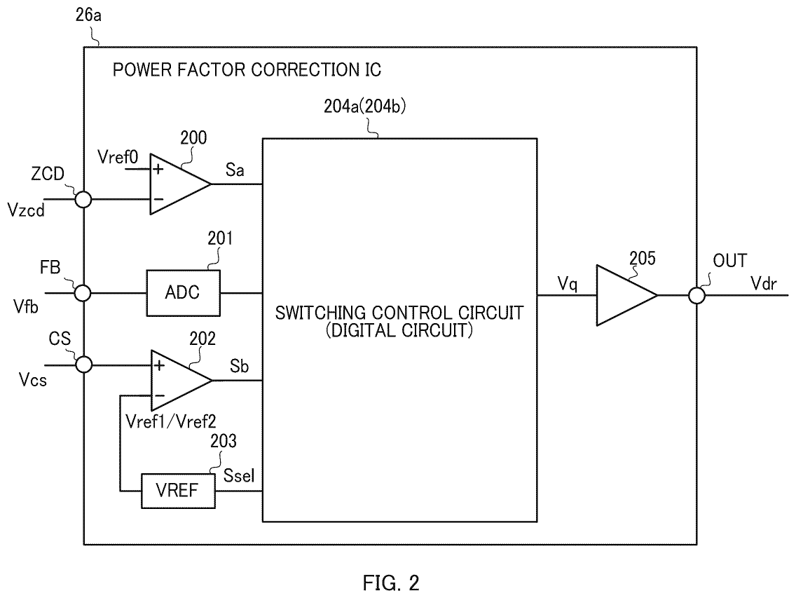

FIG. 2 is a diagram illustrating an example of the power factor correction IC 26a to perform a critical operation of the AC-DC converter 10. The power factor correction IC 26a includes comparators 200, 202, an analog-to-digital converter (ADC: AD converter) 201, a reference voltage circuit (VREF) 203, a switching control circuit 204a, and a buffer circuit 205. Note that the switching control circuit 204a is configured with a digital circuit.

The comparator 200 is a circuit to detect that the inductor current IL reaches substantially zero (hereafter, substantially zero is referred to as “zero”), and compares the voltage Vzcd and a reference voltage Vref0. In response to the voltage Vzcd dropping below the reference voltage Vref0, the comparator 200 outputs a signal Sa at a high level (hereinafter referred to as high or high level). On the other hand, in response to the voltage Vzcd exceeding the reference voltage Vref0, the comparator 200 outputs the signal Sa at a low level (hereinafter, referred to as low or low level). Further, the comparator 200 is provided to perform the critical operation of the AC-DC converter 10. Note that the reference voltage Vref0 corresponds to the voltage value of the voltage Vzcd when the inductor current IL reaches zero, and corresponds to a “first value”.

The AD converter 201 converts the voltage Vfb into a digital value.

The comparator 202 is a circuit to detect whether the inductor current IL flowing through the NMOS transistor 27 when the NMOS transistor 27 is on is an overcurrent, and compares the voltage Vcs and the reference voltage Vref1/Vref2 from the reference voltage circuit 203. Then, upon detecting that the inductor current IL is an overcurrent, the comparator 202 outputs a high signal Sb.

The reference voltage circuit 203 outputs the reference voltage Vref1, for example, when the effective value of the AC voltage Vac is 100 V, and outputs the reference voltage Vref2, for example, when the effective value of the AC voltage Vac is 240 V, in response to a signal Ssel from an estimation circuit 301 described below. Note that the voltage level of the reference voltage Vref2 is lower than that of the reference voltage Vref1. Further, the inductor current IL when the voltage Vcs reaches the reference voltage Vref1 corresponds to a “first current”, and the inductor current IL when the voltage Vcs reaches the reference voltage Vref2 corresponds to a “second current”.

Accordingly, the current value of the inductor current IL detected as an overcurrent when the effective value of the AC voltage Vac is 240 V, is smaller than the current value of the inductor current IL detected as an overcurrent when the effective value of the AC voltage Vac is 100 V. This suppresses an increase in the heat energy generated in the NMOS transistor 27, thereby suppressing damage to the NMOS transistor 27. Note that the comparator 202 corresponds to an “overcurrent detection circuit”.

The switching control circuit 204a is a circuit to output a drive signal Vq to drive the NMOS transistor 27, based on the feedback voltage Vfb and the signal Sa corresponding to the inductor current IL. The switching control circuit 204a is a digital circuit configured with a logic circuit of a wired logic type to execute various arithmetic calculations, and includes, for example, a logic gate, a flip-flop, and a memory. However, the switching control circuit 204a may be a digital signal processor (DSP) or a microcomputer. Note that details of the switching control circuit 204a will be described later.

The buffer circuit 205 is a driver circuit to drive the NMOS transistor 27 in response to the drive signal Vq. Specifically, in response to the drive signal Vq going high, the buffer circuit 205 applies, to the gate electrode of the NMOS transistor 27, the drive voltage Vdr to turn on the NMOS transistor 27, and in response to the drive signal Vq going low, the buffer circuit 205 applies, to the gate electrode of the NMOS transistor 27, the drive voltage Vdr to turn off the NMOS transistor 27.

### Configuration of Switching Control Circuit 204a

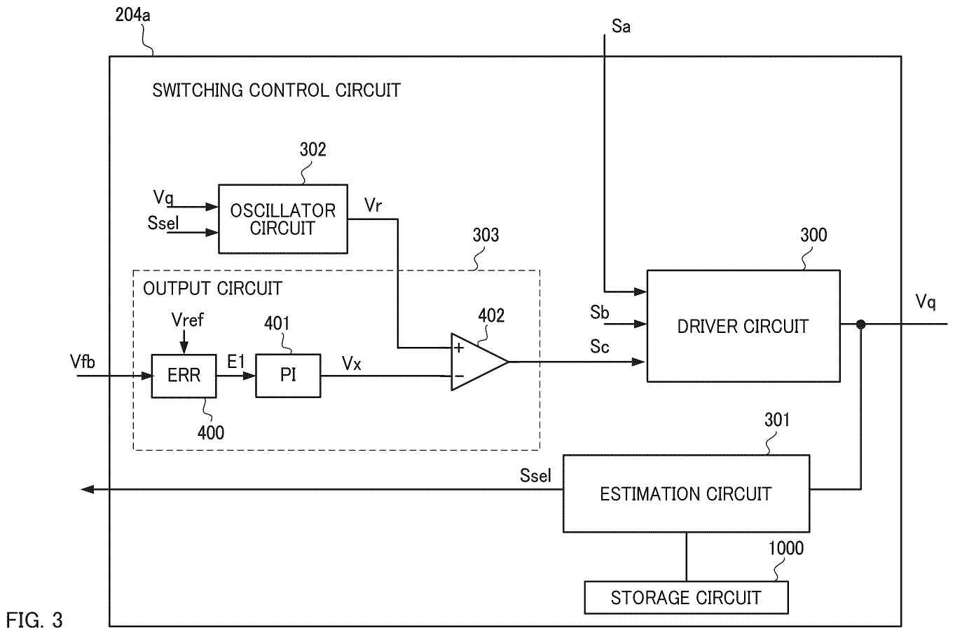

FIG. 3 is a diagram illustrating an example of the switching control circuit 204a. The switching control circuit 204a outputs the drive signal Vq, based on the inductor current IL and the feedback voltage Vfb.

The switching control circuit 204a includes a driver circuit 300, the estimation circuit 301, an oscillator circuit 302, an output circuit 303, and a storage circuit 1000.

### Driver Circuit 300

The driver circuit 300 outputs the drive signal Vq in response to the signals Sa and Sb and a signal Sc. Specifically, after the inductor current IL reaches zero and the comparator 200 in FIG. 2 outputs the high signal Sa, the driver circuit 300 outputs the high drive signal Vq, to thereby turn on the NMOS transistor 27. Thereafter, in response to an ON period Ton (described later) having elapsed and the output circuit 303 (described later) outputting the high signal Sc, the driver circuit 300 outputs the low drive signal Vq, to thereby turn off the NMOS transistor 27. Further, in response to the comparator 202 in FIG. 2 detecting that the inductor current IL flowing through the NMOS transistor 27 is an overcurrent and outputting the high signal Sb, the driver circuit 300 outputs the low drive signal Vq. Note that the time period Ton corresponds to a “first time period”.

### Estimation Circuit 301

The estimation circuit 301 estimates the effective value of the AC voltage Vac, in response to the drive signal Vq. Specifically, the estimation circuit 301 causes an OFF period Toff to be stored in the storage circuit 1000 in each switching of the NMOS transistor 27, and estimates the effective value of the AC voltage Vac, based on the stored OFF period Toff, the ON period Ton, and the output voltage.

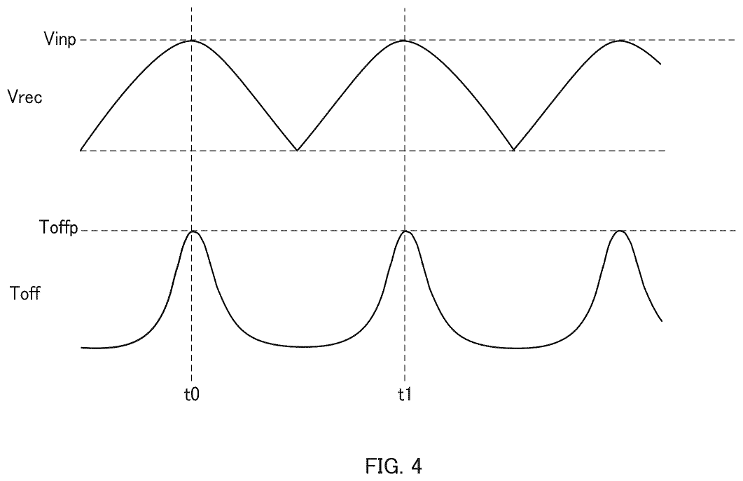

The ON period Ton is determined by the feedback voltage Vfb, and is substantially constant, for example, in a half cycle of the AC voltage Vac, in other words, one cycle of the rectified voltage Vrec, which will be described in detail later. Then, when the ON period Ton is constant, the higher the voltage level of the rectified voltage Vrec, the larger the peak value of the inductor current IL. Then, the time period after when the NMOS transistor 27 is turned off until when the inductor current IL reaches zero (that is, the OFF period Toff during which the low drive signal Vq is outputted) increases. Thus, as illustrated in FIG. 4, the OFF period Toff reaches a peak value Toffp, which is the maximum in the half cycle of the AC voltage Vac, at the time at which the AC voltage Vac, that is, the voltage level of the rectified voltage Vrec, reaches the maximum value (e.g., time t0, t1 in FIG. 4).

Then, the estimation circuit 301 detects the OFF period Toff, and causes the OFF period Toff to be stored in the storage circuit 1000 in each switching of the NMOS transistor 27. The estimation circuit 301 then calculates the time period between time t0 and time t1 in FIG. 4, for example, based on the stored OFF period Toff, to thereby determine the peak value Toffp at the timing of time t0, t1. Specifically, a peak value Vinp at the half cycle of the AC voltage Vac is calculated based on the following Expression (1):

$$V inp = V out / ( 1 + ( Ton / Toffp ) ) , \qquad Expression ( 1 )$$

where the peak value Toffp is the OFF period Toff when the stored OFF period Toff reaches the maximum in the half cycle of the AC voltage Vac.

The estimation circuit 301 then estimates the effective value of the AC voltage Vac, based on whether the calculated peak value Vinp exceeds a predetermined level. The estimation circuit 301 outputs the low signal Ssel when the effective value of the AC voltage Vac is 100 V, and outputs the high signal Ssel when the effective value of the AC voltage Vac is 240 V. Note that the predetermined level is a level capable of distinguishing whether the effective value is 100 V or 240 V (e.g., a level indicating 200 V).

Although it is assumed that the estimation circuit 301 calculates the peak value Vinp after determining the peak value Toffp, the estimation circuit 301 may calculate a voltage level Vin of the rectified voltage Vrec as needed using the OFF period Toff, and detect the peak value Vinp of the voltage level Vin. Specifically, the voltage level Vin when the calculated voltage level Vin of the rectified voltage Vrec reaches the maximum in the half cycle of the AC voltage Vac may be set as the peak value Vinp. Further, It may also be estimated that the effective value of the AC voltage Vac is 240 V when the voltage level Vin exceeds the predetermined level. Further, the OFF period Toff corresponds to a “second time period”.

Further, as in the case with the above-mentioned Japanese Patent Application Publication No. 2023-044599 as well, the timing of the peak value Toffp is detected, but because of the complexity of the calculation to perform control with high accuracy, the design and development costs increase and the circuit scale tends to be large.

### Oscillator Circuit 302

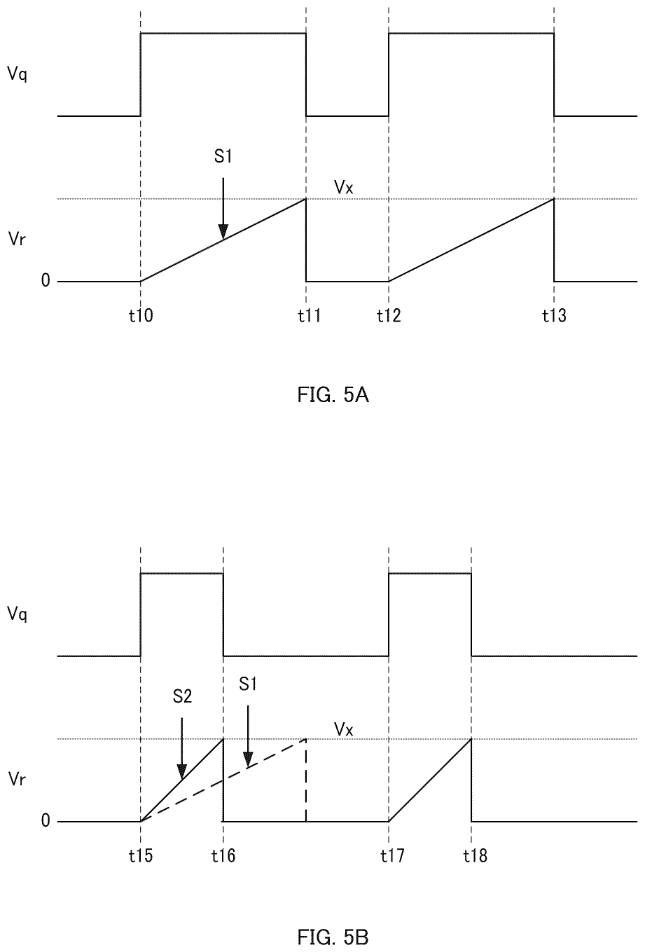

The oscillator circuit 302 changes an output Vr in response to the drive signal Vq and the signal Ssel. Specifically, when the estimation circuit 301 outputs the low signal Ssel, the oscillator circuit 302 changes the slope of the output Vr, with a slope S1, in response to the driver circuit 300 outputting the high drive signal Vq, at time t10 in FIG. 5A.

On the other hand, when the estimation circuit 301 outputs the high signal Ssel, the oscillator circuit 302 changes the slope of the output Vr, with a slope S2, which is larger than the slope S1, in response to the driver circuit 300 outputting the high drive signal Vq, at time t15 in FIG. 5A. Further, the oscillator circuit 302 outputs the output Vr of 0, in response to the driver circuit 300 outputting the low drive signal Vq, at time t11 in FIG. 5A and time t16 in FIG. 5B. Note that the oscillator circuit 302 corresponds to a “first output circuit”, the slope S1 corresponds to a “first slope”, and the slope S2 corresponds to a “second slope”. Further, the oscillator circuit 302 may also be configured with a counter with an increment value different between the slopes S1 and S2.

### Output Circuit 303

The output circuit 303 is a circuit to output the signal Sc indicating the ON period Ton, based on the output Vr and the feedback voltage Vfb. Specifically, in response to the output Vr reaching a level corresponding to the feedback voltage Vfb after the inductor current reaches zero, the output circuit 303 outputs the high signal Sc. Accordingly, the output circuit 303 outputs it during a time period, as the ON period Ton, from when the inductor current reaches zero and the driver circuit 300 outputs the high drive signal Vq until when the output circuit 303 outputs the high signal Sc, in other words, the time period during which the high drive signal Vq is being outputted.

The output circuit 303 includes an error amplifier circuit (ERR) 400, a PI control circuit (PI) 401, and a comparator 402.

The error amplifier circuit 400 calculates an error E1, which is the difference between the feedback voltage Vfb and the reference voltage Vref serving as the reference of the output voltage Vout at the target level (e.g., 400 V). Note that the feedback voltage Vfb is a digital value obtained by converting the feedback voltage Vfb by the AD converter 201 in FIG. 2.

The PI control circuit 401 calculates the integral value of the error E1, and outputs, based on the integral value, a level Vx to cause the level of the feedback voltage Vfb to be equal to the level of the reference voltage Vref.

The comparator 402 is a circuit to determine the ON period Ton, and compares the output Vr and the level Vx. Specifically, in response to the output Vr reaching a level corresponding to the feedback voltage Vfb after the inductor current reaches zero, the comparator 402 outputs the high signal Sc. On the other hand, when the output Vr does not reach the level Vx, the comparator 402 outputs the low signal Sc. Note that the output circuit 303 corresponds to a “second output circuit”.

### Operation of Switching Control Circuit 204a when Effective Value is 100 V

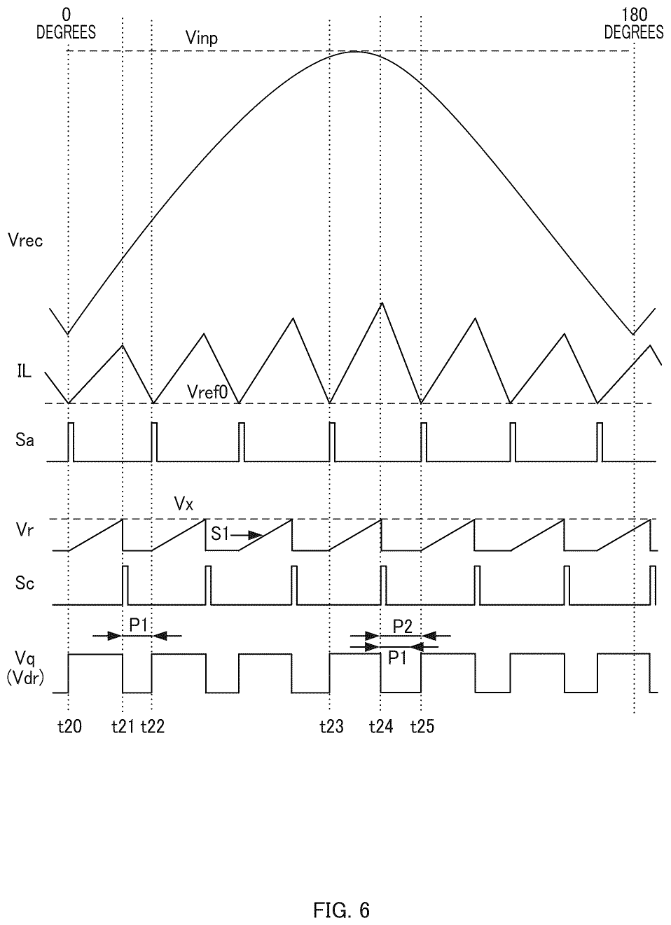

FIG. 6 is a diagram illustrating an example of an operation of the switching control circuit 204a. In FIG. 6, it is assumed that the estimation circuit 301 outputs the low signal Ssel.

First, in response to the inductor current IL decreasing to zero at time t20, the comparator 200 outputs the high signal Sa, and the driver circuit 300 outputs the high signal Vq.

In response to the driver circuit 300 outputting the high drive signal Vq, the NMOS transistor 27 is turned on, and the inductor current IL increases.

Further, in response to the drive signal Vq going high, the oscillator circuit 302 changes the slope of the output Vr, with the slope S1.

At time t21, at which the output Vr reaches the level Vx, the comparator 402 outputs the high signal Sc, and the driver circuit 300 outputs the low drive signal Vq. Then, the NMOS transistor 27 is turned off and thus the inductor current IL starts to decrease.

At time t22, at which the inductor current IL reaches zero, the NMOS transistor 27 is turned on, in the same manner as at time t10. It is assumed that the time period from time t21 to t22 is a time period P1. Thereafter, an operation continues in the same manner.

At time t23, at which the rectified voltage Vrec has a high phase angle, the NMOS transistor 27 is turned on, in the same manner as at time t20.

At time t24, at which the output Vr reaches the level Vx, the NMOS transistor 27 is turned off, in the same manner as at time t21.

Then, at time t25, at which the inductor current IL reaches zero, the NMOS transistor 27 is turned on, in the same manner as at time t22. Assuming that the time period from time t24 to t25 is a time period P2, the time period P2 is longer than the time period P1. Accordingly, the estimation circuit 301 can detect that the rectified voltage Vrec reaches the peak value Vinp around time t23.

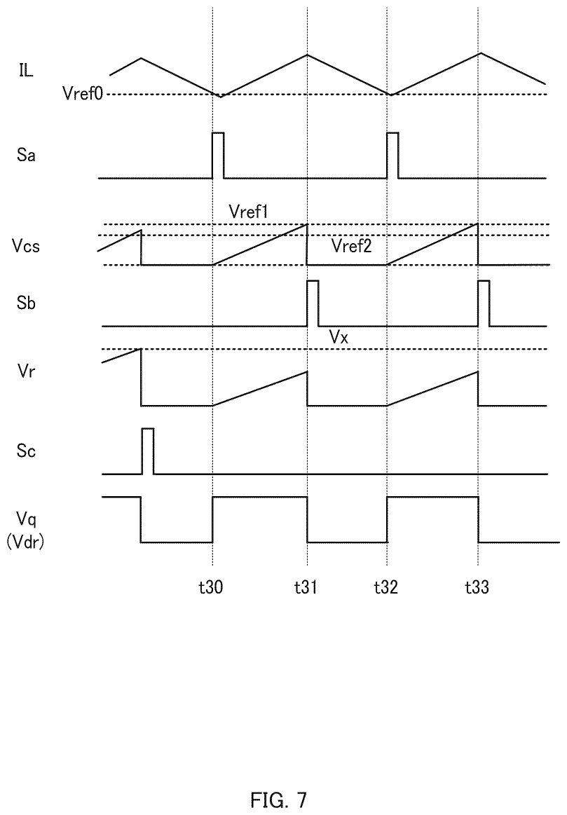

FIG. 7 is a diagram illustrating an example of an operation of the switching control circuit 204a when an overcurrent is detected. In FIG. 7, it is assumed that the estimation circuit 301 outputs the low signal Ssel.

First, at time t30, at which the inductor current IL decreases to zero, the comparator 200 outputs the high signal Sa, and the driver circuit 300 outputs the high signal Vq.

In response to the driver circuit 300 outputting the high drive signal Vq, the NMOS transistor 27 is turned on, and the inductor current IL increases.

Further, in response to the drive signal Vq going high, the oscillator circuit 302 changes the slope of the output Vr, with the slope S1.

At time t31, at which the voltage Vcs reaches the reference voltage Vref1, the comparator 202 outputs the high signal Sb, and the driver circuit 300 outputs the low drive signal Vq. Then, the NMOS transistor 27 is turned off and thus the inductor current IL starts to decrease.

At time t32, at which the inductor current IL reaches zero, the NMOS transistor 27 is turned on in the same manner as at time t30. Thereafter, an operation continues in the same manner.

The heat energy generated in the NMOS transistor 27 results in a value obtained by multiplying the rectified voltage Vrec by the inductor current IL. Thus, in the case of FIG. 7, the effective value of the AC voltage Vac is 100V, which is low, and thus the NMOS transistor 27 is unlikely to be damaged, even if the current value of the inductor current IL that is detected by the comparator 202 as an overcurrent is high.

### Operation of Switching Control Circuit 204a when Effective Value is 240V

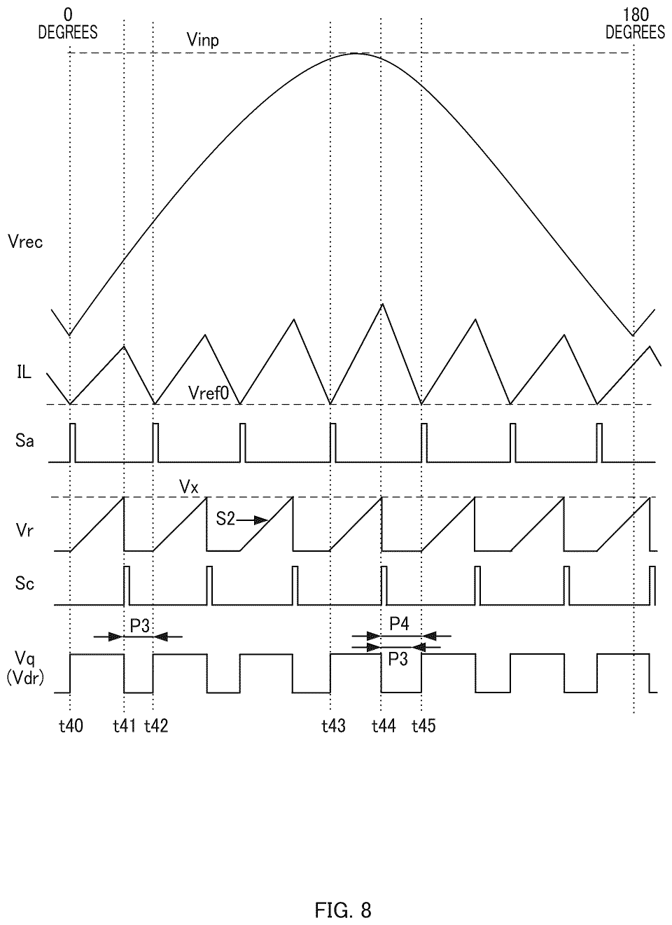

FIG. 8 is a diagram illustrating an example of an operation of the switching control circuit 204a. In FIG. 8, it is assumed that the estimation circuit 301 outputs the high signal Ssel. Further, the operation from time t40 to t45 is the same as the operation from time t20 to t25 in FIG. 6. Whereas the operation in FIG. 8 differs from the operation in FIG. 6 in that the oscillator circuit 302 changes the output Vr, with the slope S2.

As such, when the effective value of the AC voltage Vac is, for example, 240 V, which is high, the estimation circuit 301 changes the slope of the output Vr, with the slope S2, which is greater than the slope S1. This restrains the signal Sc from being unable to be outputted due to the limit of the control range of the comparator 402, even if the level Vx drops, since the output voltage Vout is high enough and the ON period Ton is enough even if being short. Further, the intermittent operation of the AC-DC converter 10 is restrained because the comparator 402 is able to output the signal Sc as such.

Further, assuming that the time period from time t41 to t42 is a time period P3 and the time period from time t44 to t45 is a time period P4, the time period P4 is longer than the time period P3. Accordingly, the estimation circuit 301 can detect that the rectified voltage Vrec reaches the peak value Vinp around time t43.

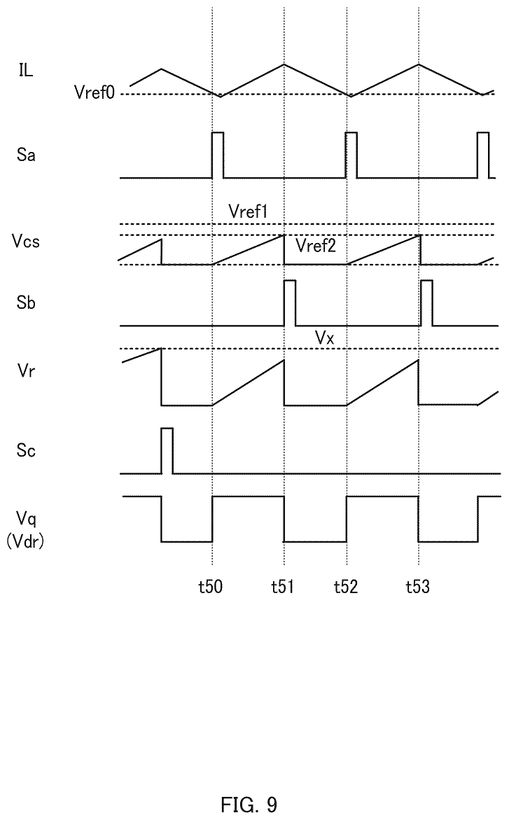

FIG. 9 is a diagram illustrating an example of an operation of the switching control circuit 204a when an overcurrent is detected. In FIG. 9, it is assumed that the estimation circuit 301 outputs the high signal Ssel. Further, the operation from time t50 to t53 is the same as the operation from time t30 to t33 in FIG. 7. Whereas the operation in FIG. 9 differs from the operation in FIG. 7 in that the reference voltage for detecting that the inductor current IL flowing through the NMOS transistor 27 is an overcurrent is the reference voltage Vref2, which is lower than the reference voltage Vref1.

In the case of FIG. 9, the effective value of the AC voltage Vac is 240V, which is high, and thus if the current value of the inductor current IL for the comparator 202 to detect an overcurrent is high, the NMOS transistor 27 may be damaged. Accordingly, the reference voltage for detecting that the inductor current IL flowing through the NMOS transistor 27 is an overcurrent is the reference voltage Vref2, which is lower than the reference voltage Vref1, and the current value detected as being an overcurrent decreases, thereby restraining damage to the NMOS transistor 27.

### Modifications

### Configuration of Switching Control Circuit 204b

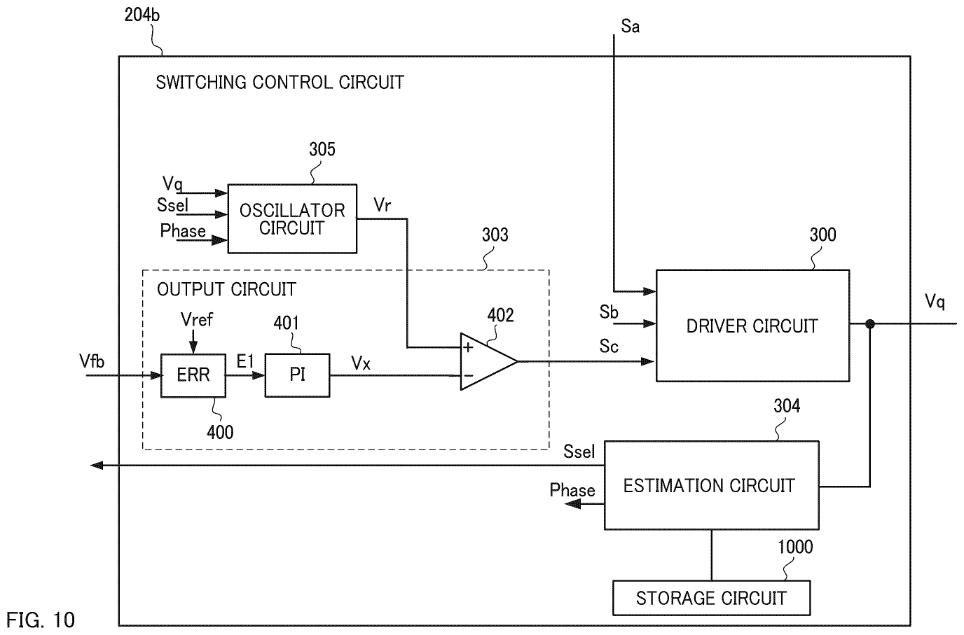

FIG. 10 is a diagram illustrating an example of a switching control circuit 204b. The switching control circuit 204b outputs the drive signal Vq, based on the inductor current IL and the feedback voltage Vfb.

The switching control circuit 204b includes the driver circuit 300, an estimation circuit 304, the output circuit 303, an oscillator circuit 305, and the storage circuit 1000.

### Estimation Circuit 304

The estimation circuit 304 causes the OFF period Toff in each switching of the NMOS transistor 27 to be stored in the storage circuit 1000, as with the estimation circuit 301. Then, the estimation circuit 304 determines the timing at which the OFF period Toff reaches the peak value (i.e., at the timing of time t0 and t1 in FIG. 4), based on the stored OFF period Toff, in association with outputting the signal Ssel. Then, the estimation circuit 304 outputs a signal Phase corresponding to the phase angle of the AC voltage Vac, in other words, the signal Phase that increases in level with an increase in the OFF period Toff. Specifically, the estimation circuit 304 outputs the signal Phase at the maximum level at time t0, t1, and outputs the signal Phase at minimum level near the middle between time t0 and t1, in other words, at which the phase angle of the AC voltage Vac is low.

### Oscillator Circuit 305

The oscillator circuit 305 changes the output Vr, in response to the drive signal Vq, the signal Ssel, and the signal Phase. Specifically, in the case where the estimation circuit 304 outputs the low signal Ssel, the oscillator circuit 305 changes the slope S1 so as to be proportional to the signal Phase when changing the slope of the output Vr, in response to the driver circuit 300 outputting the high drive signal Vq.

On the other hand, in the case where the estimation circuit 304 outputs the high signal Ssel, the oscillator circuit 305 changes the slope S2 so as to be proportional to the signal Phase when changing the slope of the output Vr, in response to the driver circuit 300 outputting the high drive signal Vq. Further, in response to the driver circuit 300 outputting the low drive signal Vq, the oscillator circuit 305 outputs the output Vr of 0. Note that the oscillator circuit 305 corresponds to the “first output circuit”.

### Operation of Switching Control Circuit 204b to Improve Dead Angle

### Operation of Switching Control Circuit 204b When Effective Value is 100 V

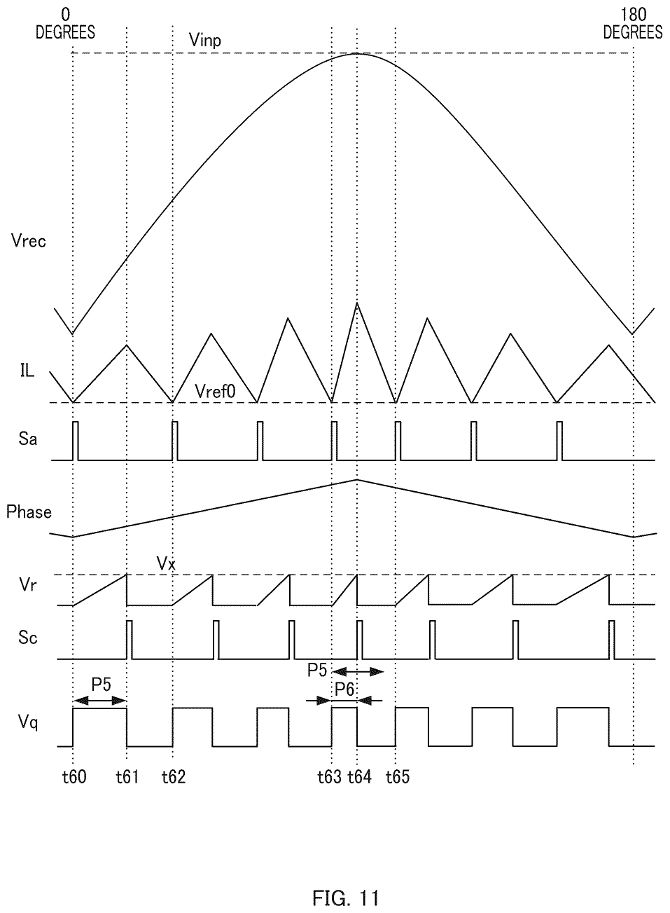

FIG. 11 is a diagram illustrating an example of an operation of the switching control circuit 204b. In FIG. 11, it is assumed that the estimation circuit 304 outputs the low signal Ssel.

First, at time t60, at which the inductor current IL decreases to zero, the comparator 200 outputs the high signal Sa, and the driver circuit 300 outputs the high signal Vq.

In response to the driver circuit 300 outputting the high drive signal Vq, the NMOS transistor 27 is turned on, and the inductor current IL increases.

Further, in response to the drive signal Vq going high, the oscillator circuit 305 changes the slope of the output Vr, with the slope S1 that is proportional to the signal Phase.

At time t61, at which the output Vr reaches the level Vx, the comparator 402 outputs the high signal Sc, and the driver circuit 300 outputs the low drive signal Vq. Then, the NMOS transistor 27 is turned off, and thus the inductor current IL starts to decrease.

At time t62, at which the inductor current IL reaches zero, the NMOS transistor 27 is turned on, in the same manner as at time t60. It is assumed that the time period from time t60 to t61 is a time period P5. Thereafter, an operation continues in the same manner.

At time t63, at which the rectified voltage Vrec has a high phase angle, the NMOS transistor 27 is turned on, in the same manner as at time t60.

At time t64, at which the output Vr reaches the level Vx, the NMOS transistor 27 is turned off, in the same manner as at time t61.

Then, at time t65, at which the inductor current IL reaches zero, the NMOS transistor 27 is turned on, in the same manner as at time t62. Assuming that the time period from time t63 to t64 is a time period P6, the time period P6 is shorter than the time period P5. Accordingly, when the AC voltage Vac, in other words, the rectified voltage Vrec, has a low phase angle, the ON period Ton increases, and when it has a high phase angle, the ON period Ton decreases. Accordingly, a large amount of the inductor current IL flows in the low phase angle, thereby restraining the distortion of the input current Iin caused by the occurrence of a dead angle in the low phase angle.

Note that the term “dead angle” refers to a phenomenon in which the current for charging the capacitor 22 stops flowing in the vicinity of a range in which the absolute value of the AC voltage Vac is small, which results in the input current Iin stopping flowing. In this case, the waveform of the input current Iin is not similar to the waveform of the AC voltage Vac, which causes deterioration of the power factor and total harmonic distortion. Further, the phrase “the absolute value of the AC voltage Vac is small” means that when the level of the AC voltage Vac is positive, the level of the AC voltage Vac is low. in other words, the AC voltage Vac has a low phase angle.

### Operation of Switching Control Circuit 204b When Effective Value is 240 V

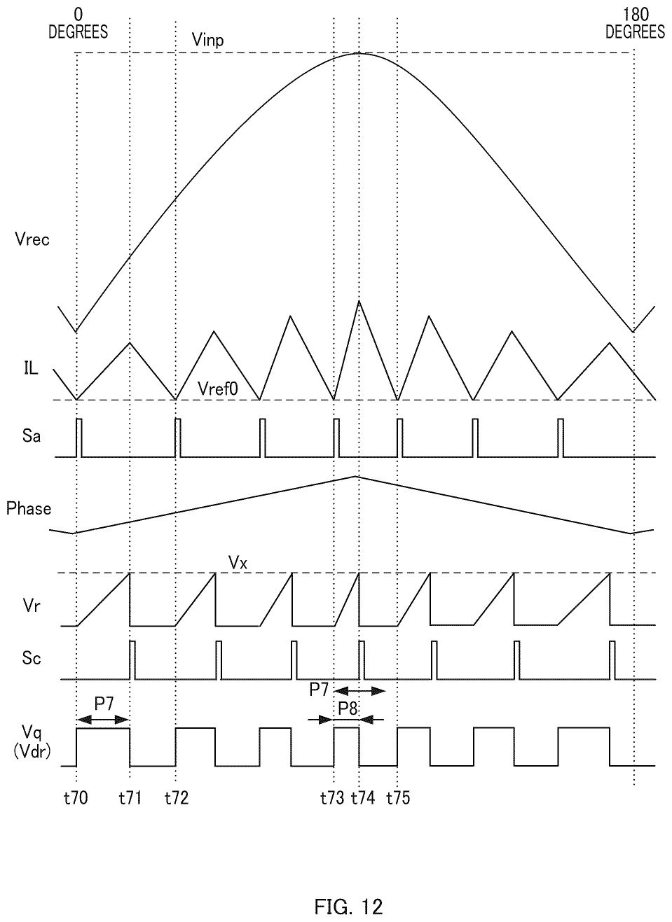

FIG. 12 is a diagram illustrating an example of an operation of the switching control circuit 204b. In FIG. 12, it is assumed that the estimation circuit 304 outputs the high signal Ssel. Further, the operation from time t70 to t75 is the same as the operation from time t60 to time t65 in FIG. 11. Whereas the operation in FIG. 12 differs from the operation in FIG. 11 in that the oscillator circuit 305 changes the output Vr, with the slope S2 that is proportional to the signal Phase.

Further, assuming that the time period from time t70 to t71 is a time period P7 and the time period from time t73 to t74 is a time period P8, the time period P8 is shorter than the time period P7. As such, even if the effective value of the AC voltage Vac is 240V, a large amount of the inductor current IL flows at a low phase angle, thereby restraining the distortion of the input current Iin caused by the occurrence of a dead angle in the low phase angle.

Further, the above-mentioned U.S. Pat. No. 7,538,525 also describes a technique of reducing a dead angle. However, in the U.S. Pat. No. 7,538,525, it is needed to provide a voltage divider circuit to detect the rectified voltage Vrec. As a result, when the technique of the U.S. Pat. No. 7,538,525 is implemented, the AC-DC converter increases in size and further increases in costs.

### Overview of AC-DC Converter 12

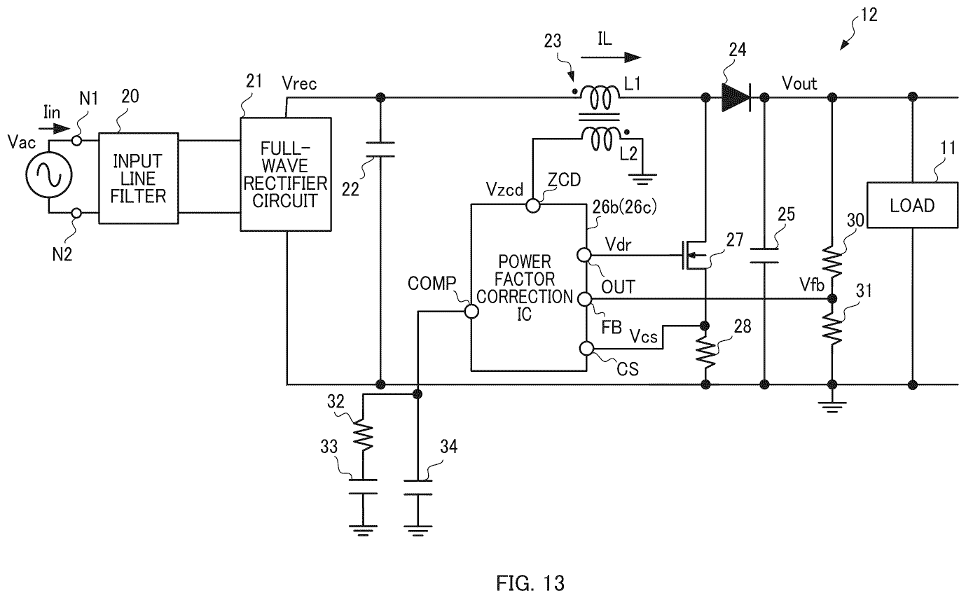

FIG. 13 is a diagram illustrating a configuration of the AC-DC converter 12. The AC-DC converter 12 is a boost PFC circuit to generate the output voltage Vout at the target level from the AC voltage Vac of the commercial power supply. Note that the AC-DC converter 12 is an example of the AC-DC converter when the power factor correction IC is configured with an analog circuit.

The AC-DC converter 12 includes the input line filter 20, the full-wave rectifier circuit 21, the capacitors 22, 25, capacitors 33, 34, the transformer 23, the diode 24, a power factor correction IC 26b, the NMOS transistor 27, and the resistors 28, 30, 31, a resistor 32. Note that the AC-DC converter 12 corresponds to the “power supply circuit”, and the current flowing from the commercial power supply to the AC-DC converter 12 is referred to as input current Iin.

The resistor 32 and the capacitors 33, 34 are elements for phase compensation of the power factor correction IC 26b, which is feedback-controlled. The resistor 32 and the capacitor 33 are provided in series between the terminal COMP, which will be described later, and the ground, and the capacitor 34 is provided in parallel with them.

### Power Factor Correction IC 26b

### Configuration of Power Factor Correction IC 26b

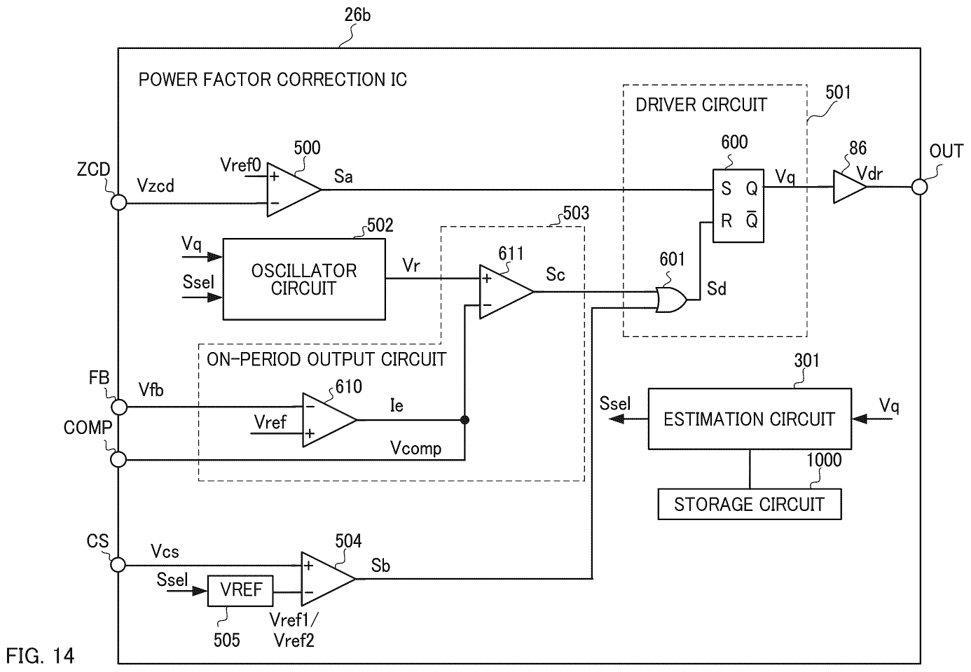

FIG. 14 is a diagram illustrating an example of the power factor correction IC 26b. The power factor correction IC 26b is an integrated circuit to control switching of the NMOS transistor 27 such that the level of the output voltage Vout reaches the target level (e.g., 400 V) while improving the input power factor of the AC-DC converter 12.

Specifically, the power factor correction IC 26b drives the NMOS transistor 27, based on the inductor current IL flowing through the main coil L1 and the output voltage Vout. The power factor correction IC 26b has the terminals ZCD, FB, OUT, CS, and a terminal COMP. Note that terminals (e.g., a ground terminal) other than the terminal ZCD and the like of the power factor correction IC 26b are omitted for convenience.

The power factor correction IC 26b includes comparators 500, 504, a driver circuit 501, an oscillator circuit 502, an ON period output circuit 503, a reference voltage circuit 505, the estimation circuit 301, and the storage circuit 1000. The estimation circuit 301 and the storage circuit 1000 are configured with digital circuits, as in the case with the switching control circuit 204a, but other circuits are configured with analog circuits, unlike the power factor correction IC 26a.

The comparator 500 is a circuit to detect that the inductor current IL reaches zero, and compare the voltage Vzcd and the reference voltage Vref0. The comparator 500 outputs the high signal Sa, in response to the voltage Vzcd dropping below the reference voltage VREF0. On the other hand, in response to the voltage Vzcd exceeding the reference voltage Vref0, the comparator 500 outputs the low signal Sa.

The driver circuit 501 outputs the drive signal Vq in response to the signals Sa, Sb, Sc. Specifically, after the inductor current IL reaches zero and the comparator 500 outputs the high signal Sa, the driver circuit 501 outputs the high drive signal Vq, to thereby turn on the NMOS transistor 27. Thereafter, in response to the ON period Ton having elapsed and the ON period output circuit 503 (described later) outputting the high signal Sc, the driver circuit 501 outputs the low drive signal Vq, to thereby turn off the NMOS transistor 27. Further, in response to the comparator 504 (described later) detecting that the inductor current IL flowing through the NMOS transistor 27 is an overcurrent to thereby output the high signal Sb, the driver circuit 501 outputs the low drive signal Vq.

The driver circuit 501 includes an SR flip-flop 600 and an OR circuit 601. The SR flip-flop 600 outputs the high drive signal Vq, in response to the comparator 500 outputting the high signal Sa, and outputs the low drive signal Vq, in response to the OR circuit 601 outputting a high signal Sd.

The OR circuit 601 is an element to perform an OR operation of the signals Sb and Sc, and reset the SR flip-flop 600 upon receiving the high signal Sb or Sc.

The oscillator circuit 502 changes the output Vr in response to the drive signal Vq and the signal Ssel. Specifically, when the estimation circuit 301 outputs the low signal Ssel, the oscillator circuit 502 changes the output Vr, with the slope S1, in response to the driver circuit 501 outputting the high drive signal Vq.

On the other hand, when the estimation circuit 301 outputs the high signal Ssel, the oscillator circuit 502 changes the slope of the output Vr, with the slope S2, which is larger than the slope S1, in response to the driver circuit 501 outputting the high drive signal Vq. Further, in response to the driver circuit 501 outputting the low drive signal Vq, the oscillator circuit 502 outputs the output Vr of 0 V. Note that the oscillator circuit 502 corresponds to the “first output circuit”.

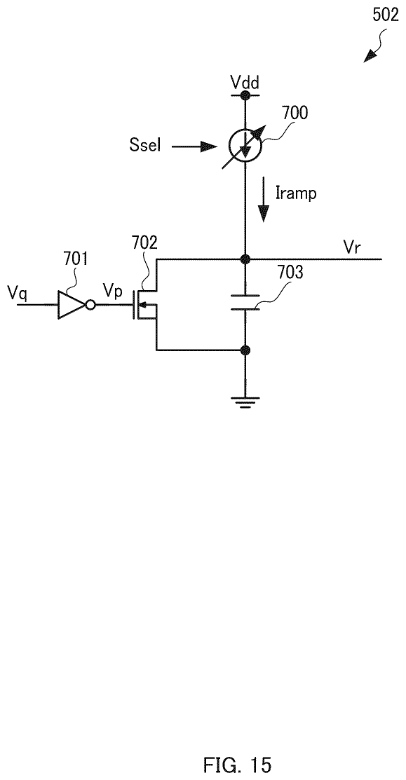

Further, the oscillator circuit 502 also includes a current source 700, an inverter circuit 701, an NMOS transistor 702, and a capacitor 703, as illustrated in FIG. 15. The current source 700 supplies a current Iramp having a larger current value to the capacitor 703 when receiving the high signal Ssel as compared with the case of receiving the low signal Ssel. Note that when the current value of the current Iramp is small, the output Vr changes with the slope S1, and when the current value of the current Iramp is large, the output Vr changes with the slope S2.

When the driver circuit 501 outputs the low drive signal Vq, the inverter circuit 701 outputs a high signal Vp, to thereby turn on the NMOS transistor 702 and discharge the capacitor 703. Accordingly, when the driver circuit 501 is outputting the low drive signal Vq, the output Vr reaches 0 V.

On the other hand, when the driver circuit 501 outputs the high drive signal Vq, the inverter circuit 701 outputs a low signal Vp, to thereby turn off the NMOS transistor 702 and charge the capacitor 703 with the current Iramp. Accordingly, when the driver circuit 501 is outputting the high drive signal Vq, the oscillator circuit 502 changes the output Vr with the slope S1 or S2 in response to the signal Ssel.

The ON period output circuit 503 is a circuit to output the signal Sc indicating the ON period Ton, based on the output Vr and the feedback voltage Vfb. Specifically, in response to the output Vr reaching the level corresponding to the feedback voltage Vfb after the inductor current reaches zero, the ON period output circuit 503 outputs the high signal Sc. Accordingly, the ON period Ton results in the time period from when the inductor current reaches zero and the driver circuit 501 outputs the high drive signal Vq until when the ON period output circuit 503 outputs the high signal Sc.

The ON period output circuit 503 includes an error voltage output circuit 610 and a comparator 611. The error voltage output circuit 610 generates an error current Ie, according to an error between the feedback voltage Vfb and the reference voltage Vref corresponding to the output voltage Vout at the target level, charges the capacitors 33, 34 through the terminal COMP, and generates a voltage Vcomp.

The comparator 611 is a circuit to compare the voltage Vcomp and the output Vr. Specifically, the voltage Vcomp is applied to the inverting input terminal of the comparator 611, and the output Vr is applied to the non-inverting input terminal of the comparator 611. Thus, when the level of the output Vr is lower than the level of the voltage Vcomp, the comparator 611 outputs the low signal Sc, and in response to the level of the output Vr exceeding the level of the voltage Vcomp, the comparator 611 outputs the high signal Sc. Note that the ON period output circuit 503 corresponds to the “second output circuit”.

The comparator 504 is a circuit to detect whether the inductor current IL flowing through the NMOS transistor 27 is an overcurrent when the NMOS transistor 27 is on, and compares the voltage Vcs and the reference voltage Vref1/Vref2 from the reference voltage circuit 505. Then, upon detecting that the inductor current IL is an overcurrent, the comparator 504 outputs the high signal Sb.

The reference voltage circuit 505 outputs the reference voltage Vref1, for example, when the effective value of the AC voltage Vac is 100 V, and outputs the reference voltage Vref2, for example, when the effective value of the AC voltage Vac is 240 V, in response to the signal Ssel from the estimation circuit 301. Note that the voltage level of the reference voltage Vref2 is lower than the voltage level of the reference voltage Vref1. Further, the comparator 504 corresponds to the “overcurrent detection circuit”.

### Power Factor Correction IC 26c

### Configuration of Power Factor Correction IC 26c

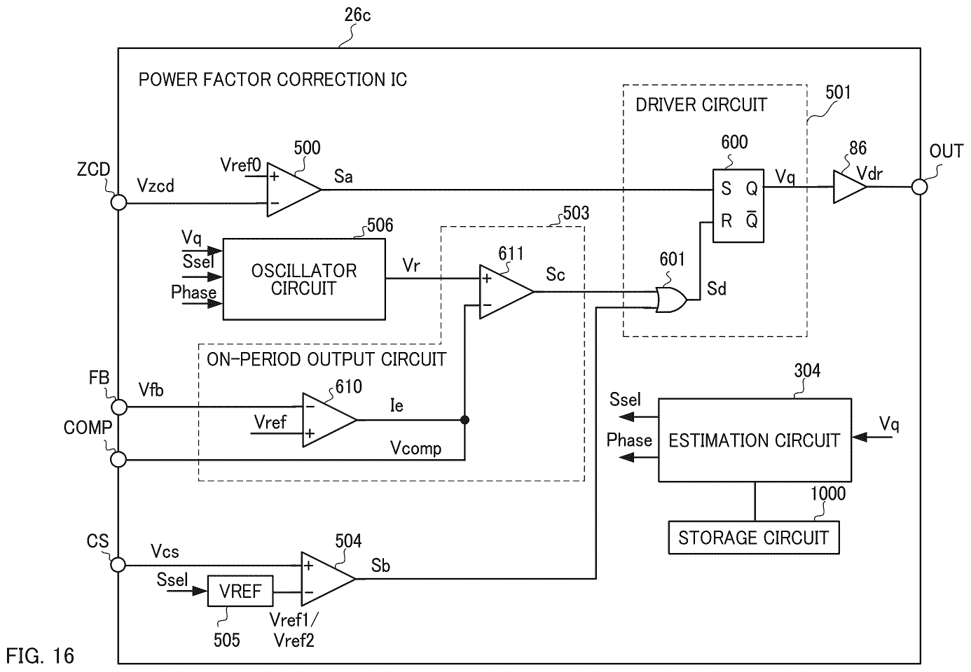

FIG. 16 is a diagram illustrating an example of a power factor correction IC 26c. The power factor correction IC 26c is an integrated circuit to control switching of the NMOS transistor 27 such that the level of the output voltage Vout reaches the target level (e.g., 400 V) while improving the input power factor of the AC-DC converter 12.

Specifically, the power factor correction IC 26c drives the NMOS transistor 27, based on the inductor current IL flowing through the main coil L1 and the output voltage Vout. The power factor correction IC 26c has the terminals ZCD, FB, OUT, CS, and COMP. Note that other terminals (e.g., a ground terminal) other than the terminal ZCD and the like of the power factor correction IC 26c are omitted for convenience.

The power factor correction IC 26c includes the comparators 500, 504, the driver circuit 501, an oscillator circuit 506, the ON period output circuit 503, the reference voltage circuit 505, the estimation circuit 304, and the storage circuit 1000. The estimation circuit 304 is configured with a digital circuit, as in the case with the switching control circuit 204b, but differs from the power factor correction IC 26b in that the oscillator circuit 506 changes the slope of the output Vr in response to the signal Phase from the estimation circuit 304.

The oscillator circuit 506 changes the output Vr in response to the drive signal Vq, the signal Ssel, and the signal Phase. Specifically, in the case where the estimation circuit 304 outputs the low signal Ssel, the oscillator circuit 506 changes the slope of the output Vr, with the slope S1, so as to be proportional to the signal Phase, in response to the driver circuit 501 outputting the high drive signal Vq.

On the other hand, in the case where the estimation circuit 304 outputs the high signal Ssel, the oscillator circuit 506 changes the slope of the output Vr, with the slope S2, so as to be proportional to the signal Phase, in response to the driver circuit 501 outputting the high drive signal Vq. Further, in response to the driver circuit 501 outputting the low drive signal Vq, the oscillator circuit 506 outputs the output Vr of 0 V. Note that the oscillator circuit 506 corresponds to the “first output circuit”.

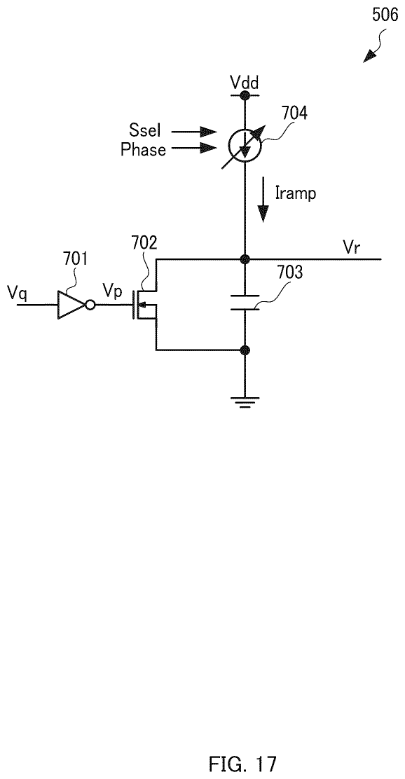

As illustrated in FIG. 17, the oscillator circuit 506 also includes a current source 704, an inverter circuit 701, an NMOS transistor 702, and a capacitor 703. The current source 704 supplies, to the capacitor 703, the current Tramp, which increases larger when receiving the high signal Ssel, as compared with the case of receiving the low signal Ssel, and causes the current value of the current Iramp to be proportional to the signal Phase. When the current value of the current Iramp is small, the output Vr changes with the slope S1 that is proportional to the signal Phase, and when the current value of the current Iramp is large, the output Vr changes with the slope S2 that is proportional to the signal Phase.

### SUMMARY

A description has been given of the AC-DC converter 10 according to an embodiment of the present disclosure. The switching control circuit 204a includes the driver circuit 300, the estimation circuit 301, the oscillator circuit 302, and the output circuit 303. The estimation circuit 301 estimates the effective value of the AC voltage Vac. The oscillator circuit 302 changes the slope of the output Vr with the slope S1, when the effective value of the AC voltage Vac is 100 V, and changes the slope of the output Vr, with the slope S2 greater than the slope S1, when the effective value of the AC voltage Vac is 240 V. When the effective value of the AC voltage Vac is high, the oscillator circuit 302 changes the output Vr with a greater slope, thereby being able to output the drive signal Vq with the shorter ON period Ton, without being affected by the limit of the control range, even if the level Vx drops. This makes it possible to provide the switching control circuit capable of switching the transistor regardless of the limit of the control range of the comparator.

Further, the estimation circuit 301 determines the peak value in the OFF period Toff, and estimates whether the effective value of the AC voltage Vac is 100 V or 240 V, based on the peak value, the ON period Ton, and the OFF period Toff. Accordingly, the AC-DC converter 10 can supply needed power to the load 11 with the larger ON period Ton, when the effective value of the AC voltage Vac is 100V, and the AC-DC converter 10 can supply as little power as needed for the load 11 with the shorter ON period Ton, when the effective value of the AC voltage Vac is 240 V.

Further, the switching control circuit 204a includes the storage circuit 1000 configured to store the OFF period Toff in each switching of the NMOS transistor 27. Accordingly, the estimation circuit 301 can determine when the timing at time t0, t1 in FIG. 4 occurs, for example, in association with determining the peak value Toffp, based on the stored OFF period.

Further, the oscillator circuit 302 increases the slope of the output Vr with an increase in the OFF period Toff. This makes it possible to reduce the dead angle that occurs at a low phase angle in the AC voltage Vac, thereby being able to supply power to the load 11 even in a low phase angle.

Further, the estimation circuit 301 determines the timing at which the OFF period Toff reaches the peak value, and the oscillator circuit 302 increases the slope of the output Vr with an increase in the OFF period Toff, based on the timing. This causes the ON period Ton to decrease and increase linearly according to the phase angle of the AC voltage Vac, thereby suppressing the dead angle that occurs at a low phase angle in the AC voltage Vac.

Further, the comparator 202 detects an overcurrent, in response to the voltage Vcs corresponding to the inductor current IL flowing through the NMOS transistor 27 reaching the reference voltage Vref1, when the effective value of the AC voltage Vac is 100 V. On the other hand, the comparator 202 detects an overcurrent, in response to the voltage Vcs corresponding to the inductor current IL flowing through the NMOS transistor 27 reaching the reference voltage Vref2, which is higher than the reference voltage Vref1, when the effective value of the AC voltage Vac is 240 V. Accordingly, an overcurrent is detected as appropriate, based on the effective value of the AC voltage Vac, thereby suppressing the damage to the NMOS transistor 27 caused by heat generation.

The present disclosure is directed to provision of a switching control circuit capable of switching a transistor regardless of the limit of a control range of a comparator.

According to the present disclosure, it is possible to provide a switching control circuit capable of switching a transistor regardless of the limit of a control range of a comparator.

Embodiments of the present disclosure described above are simply to facilitate understanding of the present disclosure and are not in any way to be construed as limiting the present disclosure. The present disclosure may variously be changed or altered without departing from its essential features and encompass equivalents thereof.

What is claimed is:

1. A switching control circuit for a power supply circuit that generates an output voltage at a target level from an alternating current (AC) voltage inputted thereto, the power supply circuit including
an inductor configured to receive a voltage corresponding to the AC voltage, and
a transistor configured to control an inductor current flowing through the inductor,
the switching control circuit being configured to control switching of the transistor, the switching control circuit comprising:
a driver circuit configured to
turn on the transistor, after the inductor current reaches a first value, and
turn off the transistor, in response to a first time period corresponding to the output voltage having elapsed;
an estimation circuit configured to estimate whether an effective value of the AC voltage is a first level or a second level higher than the first level, based on a second time period during which the transistor is off, the first time period, and the output voltage;
a first output circuit configured to, in response to the inductor current reaching the first value,
set a slope of an output thereof to a first slope, when the effective value is the first level, and
set the slope of the output thereof to a second slope greater than the first slope, when the effective value is the second level; and
a second output circuit configured to output, as the first time period, a time period from when the inductor current reaches the first value to when the output of the first output circuit reaches a level corresponding to the output voltage.

2. The switching control circuit according to claim 1, wherein the estimation circuit
determines a peak value of the second time period in a half cycle of the AC voltage, and
estimates whether the effective value of the AC voltage is the first level or the second level, based on the peak value, the first time period, and the output voltage.

3. The switching control circuit according to claim 2, further comprising:
a storage circuit configured to store the second time period in each switching of the transistor, wherein
the estimation circuit determines the peak value, based on the stored second time period in each switching of the transistor.

4. The switching control circuit according to claim 3, wherein the first output circuit increases the slope of the output thereof, with an increase in a duration of the second time period.

5. The switching control circuit according to claim 4, wherein
the estimation circuit determines a plurality of timings at each of which the second time period reaches the peak value, and
the first output circuit increase the slope of the output thereof with the increase in the duration of the second time period, based on the plurality of timings.

6. An integrated circuit for a power supply circuit that generates an output voltage at a target level from a alternating current (AC) voltage inputted thereto, the power supply circuit including
an inductor configured to receive a voltage corresponding to the AC voltage, and
a transistor configured to control an inductor current flowing through the inductor,
the integrated circuit being configured to control switching of the transistor, the integrated circuit comprising:
the switching control circuit according to claim 1; and
an overcurrent detection circuit configured to
detect a first overcurrent in the transistor, in response to a current flowing through the transistor reaching a first current, when the effective value of the AC voltage is the first level, and
detect a second overcurrent in the transistor, in response to the current flowing through the transistor reaching a second current smaller than the first current, when the effective value of the AC voltage is the second level, wherein
the driver circuit turns off the transistor, in response to the current flowing through the transistor reaching the first or second overcurrent.

7. A power supply circuit configured to generate an output voltage at a target level from an alternating current (AC) voltage inputted thereto, the power supply circuit comprising:
an inductor configured to receive a voltage corresponding to the AC voltage;
a transistor configured to control an inductor current flowing through the inductor; and
a switching control circuit configured to control switching of the transistor,
the switching control circuit including
a driver circuit configured to
turn on the transistor, after the inductor current reaches a first value, and
turn off the transistor, in response to a first time period corresponding to the output voltage having elapsed,
an estimation circuit configured to estimate whether an effective value of the AC voltage is a first level or a second level higher than the first level, based on a second time period during which the transistor is off, the first time period, and the output voltage,
a first output circuit configured to, in response to the inductor current reaching the first value,
set a slope of an output thereof to a first slope, when the effective value is the first level, and
set the slope of the output thereof to a second slope greater than the first slope, when the effective value is the second level, and
a second output circuit configured to output, as the first time period, a time period from when the inductor current reaches the first value to when the output of the first output circuit reaches a level corresponding to the output voltage.
